(19) United States
(12) Patent Application Publication
(10) Pub. No.: US 2008/0109812 A1
(43) Pub. Date: May 8, 2008

(54) Method for Managing Access to Shared Resources in a Multi-Processor Environment

(76) Inventors: Marc Vertes, Saint-Lys (FR); Philippe Bergheaud, Colmar (FR)

Correspondence Address: IBM CORPORATION;INTELLECTUAL PROPERTY LAW, 11400 BURNET ROAD, AUSTIN, TX, 78758, US

(21) Appl. No.: 11/814,490

(22) PCT Filed: Jan. 24, 2006
(86) PCT No.: PCT/EP06/50405

§ 371 Date: Jul. 23, 2007

(30) Foreign Application Priority Data
Jan. 24, 2005 (FR) 0500720

(51) Int. Cl. G06F 9/46

(52) U.S. Cl. 718/104

(57) ABSTRACT

The invention relates to a method for managing access to shared resources within a multi-processor or multi-computer environment, including while these processors are working in a physical parallelism. Such an access management is particularly useful for carrying out a control of the accesses to such resources, for example for shared memory, in order to stabilise or optimise the functioning of a process within a multi-task application using such a parallel environment. This method comprises in particular, during at least one (SchA) of its activation periods, a first task termed accessing (TA), in response to a request for access (InstrA) to said target resource, allocates an access termed continuous to said target resource, i.e. in order to exclude any access to said target resource (ShMPi) by at least one second task (TB) during the entire activation period (SchA) of the accessing task immediately after said request for access;

### FIELD OF THE INVENTION

The invention relates to a method for managing access to shared resources within a multi-processor or multi-computer environment, even while these processors are working in a physical parallelism. Such an access management is particularly useful for carrying out a control of accesses to such resources, for example shared memory, in order to stabilise or optimise the functioning of a process within a multi-task application using such a parallel environment.

### BACKGROUND OF THE INVENTION

Parallel environments are in general designed and used to obtain, from existing hardware elements, a much greater calculating power. More often than not, this applies to carrying out burdensome and complex calculations, within technical or scientific applications designed essentially with this in view.

Such an environment can be produced by integrating a number of processors within a single computer, which distribute to them the calculating work which is required of it. Several computers are sometimes also combined in a network and managed so as to share between them a certain work load, with little or no intervention by the users.

When these different specific elements, processors or computers, are capable of working at the same time on different tasks which will be reordered subsequently, the term physical parallelism is used, for example as opposed to a parallelism which would be simulated by sharing the working time of a single element in several virtual work zones.

Existing environments endowed with physical parallelism capacities, either involving multi-processors or multi-computers, are more often than not designed and optimised so as to obtain the greatest overall calculating power. For this, the different elements work decoupled as far as possible, and with very little coordination between them.

For example for reasons of cost or of flexibility, it is frequently sought to replace large central computers by micro-computers or workstations, alone or in groups. Such machines exist in multi-processor versions working in parallelism for more power, or may be grouped in order to work in parallel within a network itself constituting a single parallel working environment vis-à-vis the outside, i.e. behaving as a single respondent vis-à-vis the outside.

It may therefore be interesting to use such parallel environments to execute applications different or more varied than sheer heavy calculation applications, in particular multi-task applications of transactional type which are common in corporate management domains, or workstation networks, or communications networks. Such applications often have more varied structures and very often comprise several tasks which use shared resources within the same environment.

However, because these operating systems or these applications are designed for mono-processor machines, they are often not designed for managing interferences between two tasks being executed actually at the same time, as is the case for a physical parallelism. Thus, when several tasks being executed at the same time must access a single datum (“race condition”), the result of a reading by a task could be very different according to whether a modification by another task will have occurred before or after this reading.

Also, the majority of multi-task operating systems are not designed for managing an environment working in actual parallelism, and even less for managing shared resources in direct access. Among the types of shared access, those which are accessible by addressing from a program instruction, such as shared memory zones defined initially by an instruction of the “map” type can be qualified as direct access.

Access to this type of shared resource through direct access, by several tasks in parallel, is in general managed by the system software to a minor degree or not at all, as opposed to other shared resources which need a system call, such as resources for passing messages of the “pipe” or “socket” type, using system calls such as “open”, “read” or “write”. Management of access to shared resources through direct access is therefore more often than not almost entirely the task of the application in parallel environments.

In this type of environment, the use of existing applications not designed for this therefore often poses numerous problems if they are only modified slightly or not at all (“legacy applications”) for this purpose. In some cases, the execution can be random or even impossible, for example because of non-managed interferences between different tasks within a single application.

### SUMMARY OF THE INVENTION

One aim of the invention is to allow a management or a control of access in multi-task to shared resources within a parallel environment, which is more extensive, or more flexible or better performing.

Even if the functioning of the application is possible, its execution incorporates most often non-deterministic aspects which can pose a problem for implementing a management of the functioning of this application. Such a functioning management may be sought in order to be able to reliabilize, trace or debug or distribute (“load balancing”) the execution of such an application within one or more computers, whether they are isolated or networked, for example in the form of “clusters”.

However, this type of functioning management often comprises a logging of the functioning of one or more tasks, in order to enable later replaying of their running, in a similar or even identical manner. In order to carry out these logging or replay operations while limiting the losses of performance which this entails, it is advantageous that this running comprises as far as possible operations which are deterministic compared to the managed tasks or to the managed application, in particular in the results which these operations return.

In order to enable in this way managing such an application within one or more hardware environments comprising parallel structures, it is therefore important to be able to obtain a deterministic behaviour for as many of the operations carried out in this application as possible.

One aim of the invention is also to obtain, for all or some operations accessing the shared resources, a deterministic behaviour in a parallel environment.

For this, the invention proposes a method enabling to manage or control the access to shared resources, in particular with direct access, such that each task may obtain an exclusive access to the shared resources for the whole of a period where it is activated by the system.

This method is in particular implemented in a system software managing through sequential activation a plurality of program tasks within at least one application executed in a parallel computer system comprising a plurality of calculating means capable of executing several task simultaneously in at least two arithmetic units. In this context, the method manages access to at least one shared resource, termed target resource, accessible by said tasks.

This management thus comprises a first task termed accessing task which, during at least one of its activation periods and in response to a request for access to said target resource, receives an access termed exclusive (or “continuous”) to said target resource, i.e. in a way that excludes any access to said target resource by at least one second task during the entire rest of the activation period of the accessing task, immediately after said request for access.

This method is advantageously implemented in a parallel computer system where at least one of the arithmetic units includes an interruption mechanism capable, as a function of the value of at least one datum, termed presence datum, stored within the memory space of said computer system, of interrupting the execution of a program instruction requesting an access to a given resource, thus triggering a call to a fault management software agent.

The method also comprises the following steps:
interruption of the execution of the first instruction requesting an access to the target resource during a period of activation of the accessing task;
test by the fault manager of at least one datum, termed access datum, stored in said memory space and indicating whether said target resource is currently allocated to another task in exclusive access excluding said accessing task;
in the case of the existence of such an exclusive access already allocated to another task, suspension of the execution of the accessing task or closure of its activation period;
in the contrary case, storage in said memory space of at least one access datum representing the allocation to the accessing task of an exclusive access applying to said target resource;
during the execution of the last instruction of the period of activation of the accessing task or after this last instruction, modification of the access datum representing its exclusive access obtained for the target resource in order to release the latter.

Advantageously, the method is characterized in that, when the step of testing the access datum of the target resource indicates that the resource is free for the accessing task, the step of storing a exclusive access which follows said test step constitutes with this test step a single atomic operation within the functioning of the parallel computer system.

More particularly, the method also comprises one or more of the following steps:
after or on the suspension of a task by a software agent termed scheduler, a closure step comprising a test of all presence data corresponding to the suspended task in order to identify and release all the shared resources for which said suspended task holds an exclusive access.
before or on the release of a task by a software agent termed scheduler starting a period of activation of said task, an initialization step of all the presence data corresponding for said task to all the shared resources accessible by said task, in order that this first access request by this task to on of these shared resources, during said activation period, triggers such an interruption step.

According to one feature, the presence data initialization step is subordinate to the result of a test of the value of a datum termed management datum, corresponding to the released task and indicating whether said task should be monitored or not, i.e. whether the access management method should be applied to said task.

According to the invention, the execution of at least one application comprising at least one monitored task can be launched by a software agent termed launcher which stores at least one management datum indicating that said task must be monitored.

According to the invention, setting up the software structure carrying out the access management can in particular comprise the creation or instantiation of at least one new task by at least one creation software agent, starting from an existing task. This task creation then comprises creating at least one presence datum corresponding to said new task and relating to a shared resource, starting from a presence datum corresponding to said existing task and referring to said shared resource.

Moreover, at least one presence datum corresponding to the new task is updated by an allocation software agent, for example a mapping agent, according to the modifications made to the mapping or to the allocation of the shared resource to which said presence datum relates.

The invention also proposes to carry out this setting up and/or its update by the modification or instrumentation of purely software elements within the system, in particular in the system software.

Such modifications or instrumentation may in particular be carried out, for at least one system call, by a dynamic interposition technique using a library preloaded with modified routines.

The method according to the invention may in particular be implemented within an operating system of the Unix or Linux type, and then comprises a modification or instrumentation of system calls of the “create” or “clone” or “map” type, or of the scheduler software agent or of the release and suspension routines of the context change manager, or of the page fault handler software agent, or of the kernel memory structure data tables.

It thus may be advantageously implemented within at least one node of a computer network, for example a network constituting a cluster managed by one or more functioning management applications of the middleware type. The method may thus enable extending or optimising of the performances and functionalities of this functioning management, in particular when logging and replaying a sequence of instructions.

In the same context, the invention also proposes a system comprising the implementation of the method, applied to one or more computer systems of the parallel type or constituting a parallel system, and possibly used in a network.

### BRIEF DESCRIPTION OF THE DRAWINGS

Other features and advantages of the invention will become apparent from the detailed description of a method of embodiment, which is in no way limitative, and the appended drawings in which:

FIG. 1 is an illustration of the functioning, according to the prior art, of the access to a memory shared between two tasks executed in parallel by two different processors of a single environment;

FIG. 2 illustrates, according to the invention, the creation and maintenance, within a task, of a structure enabling control of access to memory pages shared between a number of tasks executed in parallel on several different processors of a single environment;

FIG. 3 illustrates, according to the invention, the functioning of control of access to memory pages shared by two tasks executed in parallel on two different processors of a single environment.

### DETAILED DESCRIPTION OF THE PREFERRED EMBODIMENT

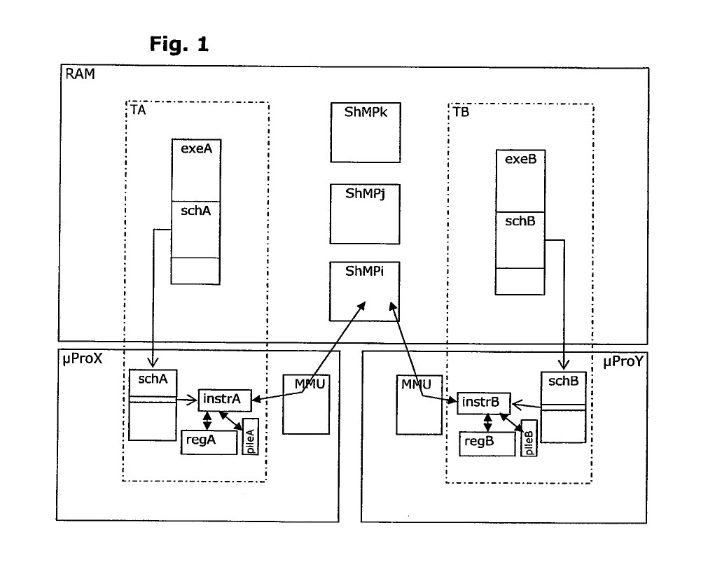

In FIG. 1 an example of the functioning of a parallel multi-processor environment is illustrated, comprising a first processor μProX and second processor μProY in a multi-processor environment, for example, a system of the Linux type. These two processors each execute a task in parallel, TA and TB respectively, within a single working memory space RAM, and are coordinated by a scheduler. During an activation period of each task TA and TB, a sequence SchA, SchB of the instructions from its program EXEA, EXEB will be executed in a processor μProX, μProY. During the execution of an instruction InstrA, InstrB from this sequence, the processor will be able to use resources which are internal to it, such as the registers RegA, RegB a stack PilA, PilB.

Within the working memory RAM, several shared memory zones ShMPi to ShMPk are defined, for example by an instruction of the “map” type, and accessible from the different tasks TA and TB directly by their physical address.

FIG. 1 illustrates a situation from the prior art, where the tasks TA and TB are executed in parallel over a common period and each comprise an instruction InstrA and InstrB requesting access to a single shared memory zone ShMPi. These two access requests will be processed 11, 13 in an independent manner by the memory manager unit MMU of each processor, and will reach 12, 14 this shared memory zone independently of each other.

For the resources which are accessible only from certain instructions of the system call type, it is possible to instrument the system routines carrying out these instructions, i.e. to modify these routines or to insert elements into the system which intercept or react to these system calls. In the context of an functioning management by logging and replay, this instrumentation may enable in particular the recording of their behaviour in order to be able to replay it later identically, or to modify this behaviour so that it becomes deterministic and has no need to be recorded.

On the contrary, for resources accessible directly without a system call, therefore potentially from any program instruction, most operating systems and in particular those of the Unix or Linux type, do not enable to control the arrival of these accesses at the level of this shared memory zone ShMPi.

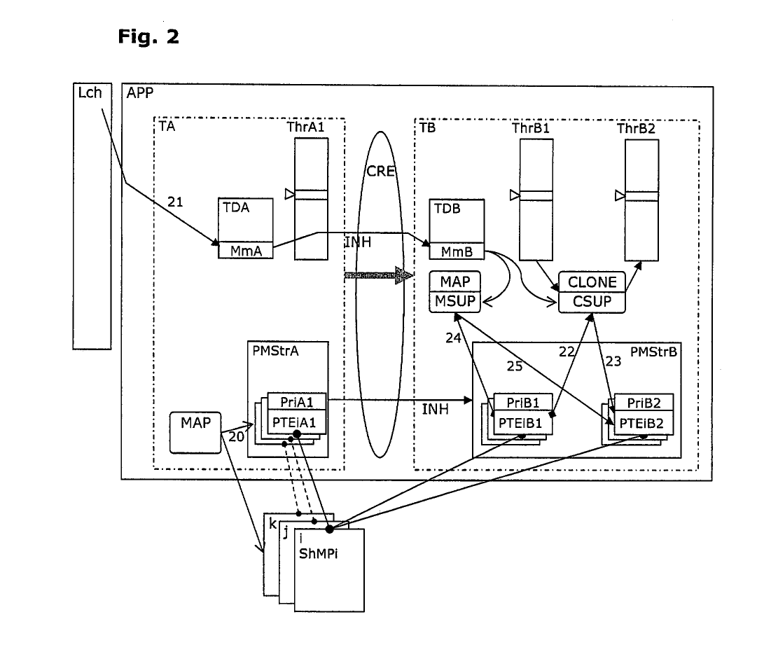

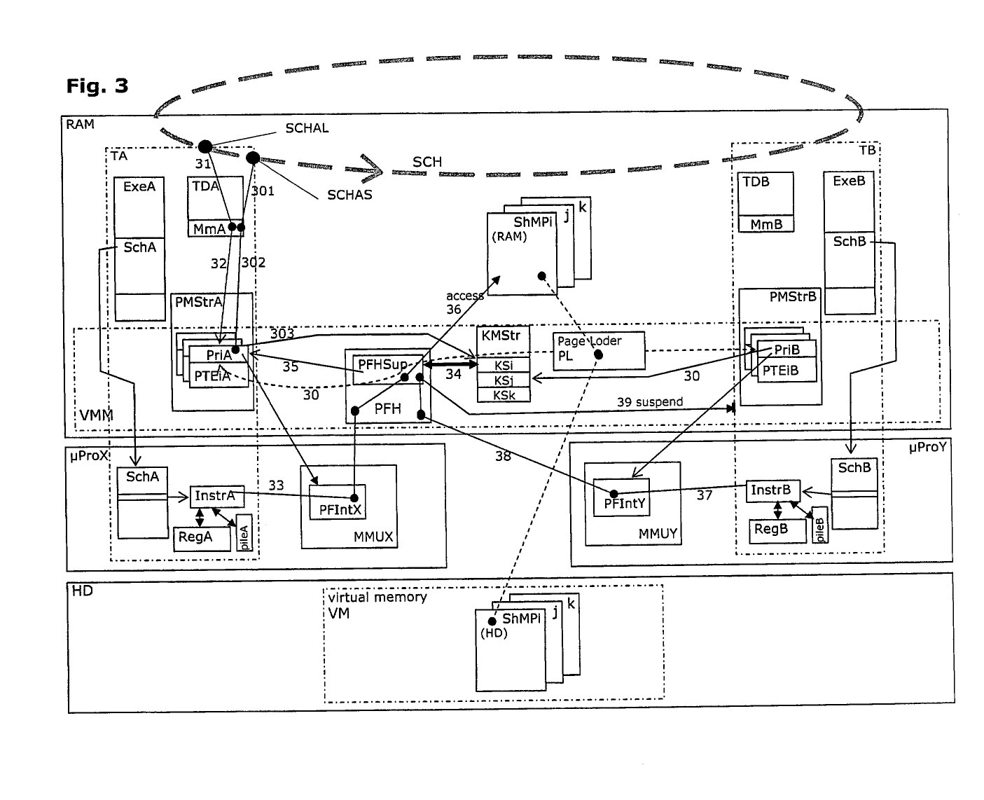

In order to resolve this problem, as illustrated in FIGS. 2 and 3, the invention proposes to modify the code of certain system software elements, or to add certain others, so as to modify or extend certain existing hardware functions, currently used for other functions.

In particular, it is possible to resolve this problem by modifying a small number of elements of a system software of the Unix or Linux type, without modifying the hardware characteristics of current processors. It is therefore possible to use machines of a common type, therefore economic and well proofed, in order to execute and manage slightly modified, or unmodified, multi-task applications, by bringing to existing system softwares only a few modifications, which add functionalities without compromising their upward compatibility.

The invention uses for this certain mechanisms existing in a number of recent micro-processors, such as the processors used in architectures of the PC type, for example Pentium processors from the Intel company, or Athlon from the AMD company. These processors, in particular since the Pentium 2, integrate within their memory management unit a virtual memory management mechanism. This mechanism is used in order to “unload” onto the hard disk certain pages defined in the working memory when they are not used, and to store them there in order to free the corresponding space within the physical memory. For the currently running applications, these pages still are listed in the working memory, but they must be “loaded” again in physical memory from the hard disk in order that a task could actually access it.

In order to manage this virtual memory, as illustrated in FIG. 3, the system software includes a virtual memory manager VMM, which creates, for each page of virtualisable memory, a page table entry (“P.T.E.”) within each of the different application processes. Thus, for two tasks TA and TB, each executed in the form of a process, i.e. with an execution context which is proprietary to it, each of the pages ShMPi to ShMPk will get a page table entry PTEiA to PTEKA in the process of the task TA, as well as a page entry table PTEiB to PTEkB in the process of the task TB.

The virtual memory manager VMM comprises a page loader software PL, which loads and unloads memory pages into a “swap” file on the hard disk, for example a file with the extension “.swp” in the Windows system from the Microsoft company. During each loading or unloading of a ShMPi page, its state of presence or non-presence in physical memory is stored and maintained 30 by the VMM manager in each of the page table entries PTEiA and PTEiB which correspond to it. Within these tables PTEiA and PTEiB, this presence state is stored in the form of a data bit PriA and PriB respectively, at the value 1 for a presence and at the value 0 for an absence.

Within each processor μProX and μProY, the memory manager MMUX or MMUY includes a page fault interrupt mechanism PFIntX or PFIntY by which passes any access request originating from an executed program instruction InstrA or InstrB. If an instruction InstrA from a task TA executed by the processor μProX requests 33 an access pertaining to a memory page ShMPi, the interruption mechanism PFIntX of the processor verifies whether this page is present in physical memory RAM, by reading the value of its presence bit PriA in the corresponding entry table PTEiA.

If this bit PriA indicates the presence of the page, the interruption mechanism PFIntX authorises the access. In the opposite case, this interruption mechanism PFIntA interrupts the execution of the task TA and transmits the parameters of the error to an “Page Fault Handler” software agent PFH included in the virtual memory manager VMM of the system software. This fault handler PFH is then executed and manages the consequences of this error within the system software and vis-à-vis the applications.

FIG. 2 illustrates how these existing mechanisms are modified and adapted or diverted in order to manage access to the shared resources according to the invention.

In order to manage these accesses from an application APP executed in such a parallel environment, as illustrated in FIG. 2, a launcher software LCH is used to launch the execution of this application, for example in a system of the Unix or Linux type. On its launch, the application APP is created with a first task TA in the form of a process comprising an execution “thread” ThrA1, and using a data table forming a task descriptor TDA.

Within this task descriptor TDA, the launcher stores 21 the fact that this task TA must be managed, or “monitored”, by modifying to 1 the state of a normally unused data bit, here termed management bit MmA.

The different shared memory zones in the working memory, here qualified as shared memory pages ShMPi, ShMPj, and ShMPk, are listed within the task TA in a data table forming a pages memory structure PMStrA. In this structure PMStrA, the shared pages are described and updated in the form of page table entries PTEiA1 to PTEkA1, each incorporating a data bit PriA1 to PrKA1 used by the virtual memory manager VMM as described previously. Typically, this pages structure PMStrA is created at the same time as the task TA, and updated 20 along with any changes in the shared memory, by the different system routines which ensure these changes, such as routines of the “map” type.

During the execution of the managed application APP, other tasks may be created by instructions CRE of the “create” type, from this first task TA or from others created in the same way. Any newly task TB created also includes a thread ThrB1 and a task descriptor TB, as well as a page memory structure PMStrB. Through an inheritance relationship INH from its parent task, the new page memory structure PMStrB also includes the different page table entries PTEiB1 to PTEkB1, with their presence bit PriB1 to PrkB1, which are maintained up to date in the same way.

On creation CRE of a new task TB from a monitored task TA, the new task descriptor TDB also comprises a management bit MmB, the value of which is inherited INH from that of the management bit MmA from the parent task.

During the execution of the managed application APP, other threads may be created within a task TB which functioned initially in the form of a process with a single thread ThrB1.

Within an existing and monitored task TB, any new thread ThrB2 is created by a system call, such as a “clone” instruction. Typically, a task in the form of a multi-thread processes comprises only one set of entry tables PTEiB1 to PTEkB1 within its pages structure PMStrB. According to the invention, the functioning of any system routine which is capable of creating a new thread, such as the “clone” system call, is modified, for example by integrating in it a supplementary part CSUP. This modification is designed so that any creation of a new thread ThrB2 in an existing task TB comprises the reading 22 of the existing set of tables PTEiB1 to PTEkB1 and the creation 23 of a new set of page table entries PTEiB2 to PTEkB2, corresponding to the same shared pages ShMPI to ShMPk and functioning specifically with the new thread ThrB2. This modification may for example be done by an instrumentation of these routines CLONE by using a technique of dynamic interposition through loading of shared libraries within the system, as described in patent FR 2 820 221 from the same applicants.

This creation is done in a way ensuring that the new tables PTEiB2 to PTEkB2 are also maintained up to date 24, 25 in a similar manner to their parent tables PTEiB1 to PTEkB1, either by registering them for updating into the system routines MAP managing this update, or by also instrumenting these system routines MAP, for example by integrating in them a supplementary part MSUP.

FIG. 3 illustrates the functioning of the access management using this structure applied to an example including two mono-thread tasks TA and TB executed in parallel in two processors μProX and μProY. It should be noted that the extension of the structure of the page table entries PTE to each thread ThrB2 cloned within each task also enable to manage in the same way any access coming from all threads belonging to monitored tasks, whether they be mono-thread or multi-thread.

In the embodiment described here, the access management according to the invention is arranged in order to guarantee to each task, in the sense of the process TA or TB as well as in the sense of each thread ThrB1 or ThrB2, an access to shared memory pages which is exclusive over the entire duration of an activation period during which their coherence (or consistency) is guaranteed by the system software. Such a period is described here as being an activation period allotted and managed by the scheduler SCH of the system software. It is clear that other types of coherence period can be chosen in the same spirit.

Also, the shared resources to which access is managed or controlled are here described in the form of shared memory, defined as specific memory zones or as memory pages. The same concept may also be applied to other types of resources by means of a similar instrumentation of the system routines corresponding to them.

The implementation of the invention may comprise a modification of some elements of the system software, so that they function as described below. The necessary level of modification may certainly vary, depending on the type or version of the system software. In the case of a system of the Linux type, these modifications comprise in general the instrumentation of “clone” and “map” type routines as described previously, as well as modifications and code additions within the agents producing the scheduler SCH, the page fault handler PFH and the page loader PL. The system functionalities to be modified to produce the type of access control described here may advantageously constitute sheer extensions compared with the functionalities of the standard system, i.e. without removing functionality or at least without compromising upward compatibility with applications developed for the standard system version.

Furthermore, although using the hardware mechanism envisaged in the processor for virtual memory management, the access control described may not necessarily need the deactivation of this virtual memory and may be compatible with it. The page loader PL may, for example, be instrumented or modified so that the loading into physical memory RAM of a virtual page ShMPi is not reflected in the presence bit PriB of this page by a monitored task TB if this page is already used by another task TA.

As illustrated in FIG. 3, at the start of one of its activation periods SchA, a task TA is released by the scheduler SCH at a time SCHAL. Before releasing this task, the scheduler SCH tests 31 the management bit MmA of this task TA to establish whether the access control must be applied to it. If this is the case, the scheduler SCH will then 32 set to 0 all the presence bits PriA to PrkA of the page table entries PTEiA to PTEKA corresponding to all the shared pages concerned by this access control, in order that any access request by this task TA causes by default a page error in the interruption mechanism PFIntX for all processors μProX where this task TA will be capable of being executed.

During this activation period SchA within the processor μProX, an instruction InstrA requests 33 an access to a shared memory page ShMPi. Because the corresponding presence bit PriA is at 0, the interruption mechanism PFIntX of the processor μProX suspends the execution of this access request and calls the page fault handler PFH of the system software, at the same time transmitting to it the identification of the page and of the task in question.

When processing this error, a supplementary functionality PFHSUP of the page fault handler PFH therefore carries out a test and/or modification within a data table forming the kernel memory structure KMStr (“Kernel Memory Structure”) agent within the virtual memory manager VMM of the system software.

Typically, this kernel memory structure KMStr stores in a univocal manner for all of the working environment, or all of the working memory, data representing the structure of the memory resources and their development. According to the invention, this kernel memory structure KMStr also comprises a set of data bits, here termed access bits KSi, KSj and KSk which represent, for each of the shared pages ShMPi to ShMPk in question, the fact that an access to this page is currently granted (bit at 1) or not granted (bit at 0) to a task.

When the page fault handler PFH processes the error transmitted by the processor μProX, it consults 34 the access bit KSi corresponding to the ShMPi page in question. If this access bit does not indicate any current access, it modifies 34 this access bit KSi in order to store that it granted an access to this page, and also modifies 35 the presence bit PriA corresponding to the requesting task TA (bit changing to 1) in order to store the fact that this task TA now has an exclusive access to the page in question ShMPPi.

It should be noted that these test and modification operations of the access bit KSi of the kernel memory structure KMStr constitute an operation 34 which is implemented in an atomic manner, i.e. it is guaranteed that it is accomplished either completely or not at all, even in a multi-processor environment.

Once the page fault handler PFInt has attributed exclusivity on the requested page ShMPi, it relaunches the execution of the instruction InstrA so that it actually accesses 36 the content of this page.

After that, if an instruction InstrB from any another monitored task TB, executed in parallel by another processor μProY, requests 37 an access to this already attributed page ShMPi, the interruption mechanism PFIntY of this processor will also consult the presence bit PriB of this page for the requesting task TB. As the task TB is a monitored task, the presence bit PriB consulted is in the absence position (value at 0). The interruption mechanism PFIntY will therefore suspend the requesting instruction InstrB and transmit 38 an error to the page fault handler PFH.

This time, this page fault handler PFH notes that the access bit KSi of this page is at 1, indicating an exclusivity has been granted already on this page ShMPi to another task. The page fault handler PFH will therefore initiate 39 a suspension of the whole of the requesting task TB, for example by ending its activation period into the system software context change manager. During its next activation period, this task TB will therefore repeat its execution exactly to the point where it was interrupted, and will be able to attempt once more to access this same page ShMPi.

In the case where the requesting task is a thread ThrB2 (FIG. 2) belonging to a multi-thread process, the existence of a set of page table entries PTEiB2 specific to this single thread ThrB2 enables to suspend only the thread which requests access to a page already allocated in exclusive access, and not the other threads ThrB1 which would not enter into conflict with this exclusivity.

On completion SCHAS of the activation period SchA of each task, the scheduler suspends the execution of this task and backs up its execution context.

On this suspension SCHAS or on a suspension 39 on a page request which is already allocated, the invention also envisages a release phase for all shared memory pages for which this task received an exclusive access. Thus, if the scheduler SCH notes 301 through the management bit MmA that the task TA in course of suspension is monitored, it scans all the page table entries PTEiA to PTEKA of this task to establish on which pages it has an exclusive access, by consulting the state of the different presence bits PriA to PrkA. Based on this information, it will then release all these pages ShMPi by resetting to 0 their access bit KSi in the kernel memory structure KMStr.

In other unrepresented variants, it is also possible to decouple the concept of management or monitoring into several types of management, for example by envisaging several management bits within a single task descriptor. A task may therefore be monitored so as to benefit from an exclusive access as regards certain categories of task. Similarly, a task may be excluded only by certain categories of task.

Thus, through suspending all the tasks which seek to access a page which is already allocated, an exclusivity of this page is obtained for the first task which requests it, without disturbing the coherence of the execution of the other tasks thus suspended.

Through avoiding any modification of a single memory zone shared by two tasks being executed at the same time, this therefore avoids any interference between them in the change of content of this memory zone. From a given initial state for this memory zone, at the start of each activation period of a task which accesses it, the change of its content thus depends only on the actions of this task during this activation period. For a given sequence of instructions executed by this task, for example a scheduled activation period, and by starting from an known initial state, it is thus possible to obtain a execution of this sequence which is deterministic and repeatable vis-à-vis this task.

Because, in particular, of the use of an atomic operation for storing the allocation of exclusivity on an accessed memory zone, the method enables to avoid or reduce the risks of deadlock of a single resource shared between a plurality of tasks seeking to access it competitively.

Moreover, due to the fact that more often than not purely the software of the invention is implemented, it is possible to use standard hardware with the advantages which this incorporates.

It should be noted that the functioning of the access control described here uses the software part in a manner dissociated completely from the hardware part, in the sense where neither the system software nor the application needs to know or fix the choice of processor in which each task will be executed during its release. Good independence with respect to the hardware is then obtained, which, in particular, makes the implementation simpler and more reliable and conserves good performances while allowing the architecture itself to best manage the parallelism of the different calculating elements, which are the processors or computers.

The invention can in particular extend to parallel environments operational management techniques developed for multi-task applications functioning in shared time over a single calculating element. The invention can thus in particular integrate such parallel environments into networks or clusters, in which this operational management is implemented within an application of the middleware type, for example in order to manage distributed applications or variable deployment applications providing an “on-demand” service.

Obviously, the invention is not limited to the examples which have just been described and numerous amendments may be made thereto, without departing from the framework of the invention.

1. Method for access management, implemented with a system software managing through sequential activation a plurality of program tasks (TA, TB) within at least one computer application (APP) executed in a parallel computer system, comprising a plurality of calculation means capable of executing several tasks simultaneously in at least two arithmetic units (μProX, μProY), this method managing access to at least one shared resource, termed target resource (ShMPi), accessible by said tasks (TA, TB),
characterized in that, during at least one (SchA) of its activation periods, a first task termed accessing (TA), in response to a request for access (InstrA) to said target resource, receive an access termed exclusive to said target resource, i.e. in a way that excludes any access to said target resource (ShMPi) by at least one second task (TB) during the entire rest of the activation period (SchA) of the accessing task, immediately after said request for access.

2. Method according to claim 1, characterized in that at least one of the arithmetic units (μProX) includes an interruption mechanism (PFIntX) capable, as a function of the value of at least one datum termed presence datum (PriA), stored within the memory space (RAM) of said parallel computer system, of interrupting the execution of a program instruction requesting an access to a given resource, thus triggering a call to a fault handling software agent, this method also comprising the following steps:
interruption (PFIntX, PFIntY) of the execution of the first instruction (InstrA, Instrb) requesting (33, 37) an access to the target resource during a period of activation (SchA, SchB) of the accessing task (TA, TB);
test (34) by the fault handler (PFH) of at least one datum, termed access datum (KSi), stored in said memory space and indicating whether said target resource is currently allocated to another task in an exclusive access excluding said accessing task (TA, TB);
in the case of the existence of such an exclusive access already allocated to another task (TA), suspension (39) of the execution of the accessing task (TB) or closure of its activation period;
in the contrary case, storage (34) in said memory space of at least one access datum (KSi) representing the allocation to the accessing task (TA) of an exclusive access applying to said target resource (ShMPi);
during the execution of the last instruction of the period of activation (SchA) of the accessing task (TA) or after this last instruction, modification (303) of the access datum (KSi) representing its exclusive access obtained for the target resource in order to release the latter (ShMPi).

3. Method according to claim 2, characterized in that, when the step of testing the access datum of the target resource indicates that the resource is free for the accessing task, the step of storing a exclusive access which follows said test step constitutes with this test step a single atomic operation (34) within the functioning of the parallel computer system.

4. Method according to claim 2, characterized in that it also comprises, after or on the suspension (SCHAL) of a task (TA) by a software agent termed scheduler (SCH), a closure step comprising a test (302) of all the presence data (PriA to PrkA) corresponding to the suspended task (TA) so as to identify and release all the shared resources for which said task holds an exclusive access.

5. Method according to claim 2, characterized in that it also comprises, before or on the release (SCHAL) of a task (TA) by a software agent termed scheduler (SCH) starting a period of activation (SchA) of said task, an initialization step (33) of all the presence data corresponding for said task to all the shared resources (ShMPi to ShMPk) accessible by said task (TA), in order that each first access request by this task to one of these shared resources, during said activation period, triggers an interruption step (PFIntX).

6. Method according to claim 5, characterized in that the presence data initialization step (33) is subordinate to the result of a test (31) of the value of a datum termed management datum (MmA), corresponding to the released task (TA) and indicating whether said task should be monitored or not, i.e. whether the access management method should be applied to said task.

7. Method according to claim 1, characterized in that at least one new task (ThrB2) is instantiated or created by at least one creation software agent (CLONE, CSUP) from an existing task (ThrB1), this creation comprising creating (22, 23) at least one presence datum (PriB2) corresponding to said new task (ThrB2) and related to a shared resource (ShMPi), starting from a presence datum (PriB1) corresponding to said existing task (ThrB1) and related to said shared resource.

8. Method according to claim 7, characterized in that at least one presence datum (PriB2) corresponding to the new task (ThrB2) is updated by an allocation software agent (MAP, MSUP), according the modifications made to the allocation of the shared resource (ShMPi) to which said presence datum relates.

9. Method according to claim 6, characterized in that the execution of at least one application (APP) comprising at least one monitored task (TA) is launched by a software agent termed launcher (LCH) which stores at least one management datum (MmA) indicating that said task (TA) must be monitored.

10. Method according to claim 1, characterized in that it is implemented within an operating system of the Unix or Linux type, and comprises a modification or instrumentation of system calls of the “create” or “clone” or “map” type, or of the scheduler software agent (SCH) or of the release and suspension routines of the context change manager, or of the page fault handler software agent (PFH), or of the kernel memory structure data tables (KMStr).

11. Method according to claim 10, characterized in that at least one system call is instrumented through a dynamic interposition technique using a preloaded library of modified routines.
